(19) United States
(12) Patent Application Publication
(10) Pub. No.: US 2021/0241117 A1
(43) Pub. Date: Aug. 5, 2021

(54) METHOD FOR PROCESSING BATCH-NORMALIZED DATA, ELECTRONIC DEVICE AND STORAGE MEDIUM

(71) Applicant: SHENZHEN SENSETIME TECHNOLOGY CO., LTD., Shenzhen (CN)

(72) Inventors: Xinjiang WANG, Shenzhen (CN); Sheng ZHOU, Shenzhen (CN); Litong FENG, Shenzhen (CN); Wei ZHANG, Shenzhen (CN)

(21) Appl. No.: 17/234,202

(22) Filed: Apr. 19, 2021

Related U.S. Application Data
(63) Continuation of application No. PCT/CN2019/110597, filed on Oct. 11, 2019.

(30) Foreign Application Priority Data
Jul. 19, 2019 (CN) 201910656284.2

(51) Int. Cl. G06N 3/08; G06N 3/04

(52) U.S. Cl. CPC G06N 3/084; G06N 3/04

(57) ABSTRACT

A method for processing batch-normalized data, an electronic device, and a storage medium are provided. The method includes: a plurality of sample data are input into a batch normalization (BN) layer in a target network to be trained for normalization to obtain a processing result of the BN layer, wherein the plurality of sample data are obtained by extracting features of a plurality of image data; a shift adjustment of initial BN is performed on the processing result of the BN layer according to a specified constant shift to obtain a processing result of a post-shifted BN layer; and the processing result of the post-shifted BN layer is nonlinearly mapped through a rectified linear unit (ReLU) of an activation layer, a loss function is obtained step by step and then back propagation is carried out to obtain a first target network.

### CROSS-REFERENCE TO RELATED APPLICATION

The present disclosure is a continuation application of International Patent Application No. PCT/CN2019/110597, filed on Oct. 11, 2019, which claims the priority of Chinese Patent Application No. 201910656284.2 entitled “METHOD AND DEVICE FOR PROCESSING BATCH-NORMALIZED DATA, ELECTRONIC DEVICE AND STORAGE MEDIUM” and filed on Jul. 19, 2019. The disclosures of International Patent Application No. PCT/CN2019/110597 and Chinese Patent Application No. 201910656284.2 are incorporated herein by reference in their entireties.

### TECHNICAL FIELD

The present disclosure relates to the technical field of data processing, and in particular to a method for processing batch-normalized data, an electronic device and a storage medium.

### BACKGROUND

Adopting batch normalization (BN) in a deep neural network can not only prevent the deep neural network from diverging even if the maximum learning rate is adopted, but also increase the generalization performance of the deep neural network. An activation layer may be connected after a BN layer, and the activation function used by the activation layer may be a rectified linear unit (ReLU). It is necessary to improve the performance of the BN+ReLU deep neural network.

### SUMMARY

In a first aspect, provided is a method for processing batch-normalized data, including:

inputting a plurality of sample data into a batch normalization (BN) layer in a target network to be trained for normalization to obtain a processing result of the BN layer, wherein the plurality of sample data are obtained by extracting features of a plurality of image data;

performing a shift adjustment of initial BN on the processing result of the BN layer according to a specified constant shift to obtain a processing result of a post-shifted BN layer; and

nonlinearly mapping the processing result of the post-shifted BN layer through a rectified linear unit (ReLU) of an activation layer, obtaining a loss function step by step and then carrying out back propagation to obtain a first target network.

In a second aspect, provided is a device for processing batch-normalized data, including:

a normalizing unit, configured to input a plurality of sample data into a batch normalization (BN) layer in a target network to be trained for normalization to obtain a processing result of the BN layer, wherein the plurality of sample data are obtained by extracting features of a plurality of image data;

a shift unit, configured to perform a shift adjustment of initial BN on the processing result of the BN layer according to a specified constant shift to obtain a processing result of a post-shifted BN layer; and

a processing unit, configured to nonlinearly map the processing result of the post-shifted BN layer by a rectified linear unit (ReLU) through an activation layer, obtain a loss function step by step and then carry out back propagation to obtain a first target network.

In a third aspect, provided is an electronic device, including:

a processor, and

a memory configured to store an instruction that, when executed by the processor, causes the processor to perform the following operations including:

inputting a plurality of sample data into a batch normalization (BN) layer in a target network to be trained for normalization to obtain a processing result of the BN layer, wherein the plurality of sample data are obtained by extracting features of a plurality of image data;

performing a shift adjustment of initial BN on the processing result of the BN layer according to a specified constant shift to obtain a processing result of a post-shifted BN layer; and

nonlinearly mapping the processing result of the post-shifted BN layer through a rectified linear unit (ReLU) of an activation layer, obtaining a loss function step by step and then carrying out back propagation to obtain a first target network.

In a fourth aspect, provided is a non-transitory computer-readable storage medium. The non-transitory computer-readable storage medium has stored thereon a computer program instruction that, when executed by a processor, causes the processor to perform a method for processing batch-normalized data, the method comprising:

inputting a plurality of sample data into a batch normalization (BN) layer in a target network to be trained for normalization to obtain a processing result of the BN layer, wherein the plurality of sample data are obtained by extracting features of a plurality of image data;

performing a shift adjustment of initial BN on the processing result of the BN layer according to a specified constant shift to obtain a processing result of a post-shifted BN layer; and

nonlinearly mapping the processing result of the post-shifted BN layer through a rectified linear unit (ReLU) of an activation layer, obtaining a loss function step by step and then carrying out back propagation to obtain a first target network.

It is to be understood that both the foregoing general descriptions and the following detailed descriptions are exemplary and explanatory, and are not restrictive of the disclosure, as claimed.

Further features and aspects of the present disclosure will become apparent from the following detailed description of exemplary embodiments with reference to the accompanying drawings.

### BRIEF DESCRIPTION OF THE DRAWINGS

The accompanying drawings herein are incorporated in the specification, become a part of the specification, show embodiments that are in accordance with the present disclosure, and are used with the specification to explain technical solutions of the present disclosure.

FIG. 1 shows a flow chart of a method for processing batch-normalized data according to an embodiment of the present disclosure.

FIG. 2 shows a schematic diagram of a shift processing effect applied to an image classification scenario according to an embodiment of the present disclosure.

FIG. 3 shows a schematic diagram of a shift processing effect applied to a transfer learning scenario according to an embodiment of the present disclosure.

FIG. 4 shows a block diagram of the device for processing batch-normalized data according to an embodiment of the present disclosure.

FIG. 5 is a block diagram of an electronic device according to an embodiment of the present disclosure.

FIG. 6 is a block diagram of an electronic device according to an embodiment of the present disclosure.

### DETAILED DESCRIPTION

Various exemplary embodiments, features, and aspects will be described in detail below with reference to the accompanying drawings. Like accompanying symbols in the accompanying drawings represent elements with like or similar functions. Although various aspects of the embodiments are illustrated in the accompanying drawing, the accompanying drawings are not necessarily drawn in proportion unless otherwise specified.

The special term “exemplary” herein refers to “can be used as an example, an embodiment, or an illustration”. Any embodiment described as “exemplary” herein is not necessarily to be interpreted as being superior to or better than other embodiments.

The term “and/or” in this specification describes only an association relationship between associated objects and represents that three relationships may exist. For example, A and/or B may represent the following three cases: Only A exists, both A and B exist, and only B exists. In addition, the term “at least one of” in this specification represents any one or any combination of at least two of the listed items. For example, “at least one of A, B, and C” may represent any one element or multiple elements selected from a set including A, B, and C.

In addition, for better illustration of the present disclosure, various specific details are given in the following specific implementation. A person skilled in the art should understand that the present disclosure may also be implemented without the specific details. In some instances, methods, means, elements, and circuits well known to a person skilled in the art are not described in detail, so as to highlight the subject matter of the present disclosure.

In the deep neural network, BN is often an indispensable normalization method. BN not only can enable the neural network to utilize the maximum learning rate without divergence, but also can increase the generalization performance of a model. The ReLU is a nonlinear activation function in the neural network. Compared with other nonlinear activation functions (such as, Sigmoid, Tanh, etc.), the activation value of the ReLU is constantly 0 when a negative value is input. Therefore, ReLU can express the sparse attribute of features, thus making the training of the network converge faster.

In terms of the sparse attribute, the output of part of neurons in the neural network will be 0 due to the ReLU, that is, weights for parameter computation in the neural network are 0 (from the global perspective, this means that part of weights are removed), thus causing the network to have sparsity, reducing the interdependence between the parameters and alleviating the occurrence of overfitting problem. As the weights for parameter computation in the neural network are 0 (from the global perspective, this means that part of weights are removed), computation is faster, and the training of the network can converge faster. In an example, there are 100,000 weights for parameter computation, and if the neural network is deployed on a terminal (such as a mobile phone or a vehicle) that cannot bear excessive computation load, the amount of computation will be large. In contrary, when part of the weights are 0 (that is, part of the weights are removed from computation), the network has sparsity, which not only won't affect the network performance of the neural network too much but also can increase the operating efficiency of the neural network deployed on the terminal (such as a mobile phone or a vehicle), so that computation load does not exceed expectation. Then, such network sparsity is a sparsity result expected by users, and can be called benign sparsity.

In terms of sparsity, if there are too many network channels (network channels composed of at least one corresponding input and output in the neural network) with a weight of 0 in the neural network, poor sparsity will occur, which is unfavorable, and such poor sparsity needs to be removed or inhibited.

As the sparsity of the network can reduce the amount of data computation, considering the advantage of sparsity of the network, if network channels (network channels composed of at least one corresponding input and output in the neural network) with a weight of 0 exist in the neural network, then the number of network parameters is reduced, and thereby the operating efficiency can be increased. Therefore, when part of the weights for parameter computation in the neural network are set to 0 (from the global perspective, this means that part of the weights are removed), computation can become faster. When the present disclosure is adopted, after the processing result of the post-shifted BN layer is nonlinearly mapped through the ReLU, back propagation for the loss function is carried out, and the obtained first target network can perfect both aspects; a plurality of sample data are then input into the BN layer in the target network to be trained for normalization, so that a processing result of the BN layer is obtained; a shift adjustment of initial BN is then performed on the processing result of the BN layer according to a specified constant shift, and by giving different values to the constant shift, different processing results of the post-shifted BN layer can be obtained. For example, when the constant shift is a positive number, by BN layer shift processing, the network sparsity of the first target network can be inhibited; and when the constant shift is a negative number, by BN layer shift processing, the network sparsity of the first target network can be promoted, obtaining a pruned network. In terms of the pruned network, the heavy computation of the deep network can be reduced by the pruned network. A typical pruned network is described step by step as follows: a large network model is first trained, pruning is performed, and finally, the network model is finely adjusted. In the process of pruning, according to a standard expected by users, redundant weights are pruned (removing parts of weights), with only important weights kept, so that the accuracy and performance of the network model are ensured. As a model compression method, pruning introduces sparsity into the dense connection of the deep neural network and reduces the number of non-zero weights by directly setting “unimportant” weights to zero to achieve the objective of increasing the operating efficiency of the network model.

Due to normalization in the BN layer, when the activation layer (including the ReLU for executing nonlinear mapping) is connected after the BN layer, a stable untrainable region will appear for the parameters of the BN layer in the neural network at the initial stage of the network or under the condition of a high learning rate. After the parameters enter the region, a gradient cannot be obtained from the sample data and updated, so it can only approach 0 under the action of an L2 loss function, causing the network channel to be pruned.

In terms of the untrainable region, the untrainable region means that when the input parameter entering the ReLU of the activation layer is a negative number, the input of the ReLU is constantly equal to 0, and no gradient is returned. One reason why the untrainable region appears is as follows: when the two parameters γ and β of the BN layer are respectively a small value (e.g. 0.1) and a negative value (e.g. −100), the output result of the BN layer is constantly equal to 0 after being nonlinearly mapped by the ReLU, and as a result, gradient derivation cannot be performed, that is, no gradient is returned, and consequently, gradient descent cannot be performed in subsequent back propagation for the loss function, leading to the parameters unable to be updated.

To sum up, in practical application, the inventor discovered that the probability of parameters entering an untrainable region in a BN+ReLU network was random at the initial stage of training and due to a high learning rate, but still showed partial selectivity in the process of training, that is, the parameters with less influence on loss would be more likely to enter the untrainable region and pruned. Therefore, this phenomenon exhibits the two sides of the description. On one hand, as a pruning method, it can reduce the numbers of parameters of the network under the condition that network performance is basically unchanged, so such sparsity needs to be promoted; on the other hand, it can also decrease the expressing ability of the network, causing the performance of the network to become poor, so such sparsity needs to be inhibited.

As the BN+ReLU network combination is adopted in the deep neural network, it may cause part of the network channels (such as the channels for BN parameters) to be unable to be trained to collapse (further leading to convolution computation unable to be trained as well). Therefore, on one hand, the present disclosure improves the mode of BN, that is, a specified constant shift (a positive number at this point) is increased to perform a shift adjustment for initial BN. According to the adjusted processing result of the post-shifted BN layer, the network parameters that enter the untrainable region at the initial stage of network training or due to a high learning rate can return into the trainable region again under the action of the L2 loss function, and consequently, the expressing ability of the network is ensured, and sparsity is inhibited. The method can solve the problem that the BN+ReLU network combination may cause part of the network channels to be unable to be trained to collapse. This solution adds a specified positive constant shift (such as a constant α) on the original mode of each BN to enable the network to have a pruning effect and the network parameters located in the untrainable region in the process of training to return into the trainable region again, thus increasing the performance of the network. On the other hand, the present disclosure improves the mode of BN, that is, a specified constant shift (a negative number at this point) is added to perform a shift adjustment for initial BN. According to the adjusted processing result of the post-shifted BN layer, on the basis of being fully compatible with the expressing ability of the original BN, the network can be directly trained to obtain a pruned network by adjusting the additional shift of the BN bias term. Since the mode of the original BN is finely adjusted, this solution is referred to as post-shifted batch normalization (psBN), a user can choose a symbol for a corresponding shift constant α according to a requirement of the user (for example, the user wants to improve the performance of the network or increase the channel sparsity of the network), that is, the value of α is chosen to be a positive number or a negative number according to the requirement of the user.

It should be pointed out that multiple BN layers may exist in a network. In the present disclosure, for each BN layer, a shift adjustment can be performed on the BN layer according to an added constant shift to obtain a processing result of the post-shifted BN layer. Moreover, the constant shift employed in the multiple BN layers can be a unified shift. That is, at least one BN layer in the same network is added with the constant shift, and the same value is set. The specific value is set according to the requirement of the user, and the constant shift may be a positive number or a negative number.

For each BN layer, when the value of the constant shift is a positive number, and a shift adjustment is performed on initial BN according to the constant shift to obtain a processing result of the post-shifted BN layer, so that network parameters that enter an untrainable region in the target network to be trained can be retransferred into a trainable region by means of the processing result of the post-shifted BN layer.

For each BN layer, when the value of the constant shift is a negative number, a shift adjustment is performed on initial BN according to the constant shift to obtain a processing result of the post-shifted BN layer, and then network parameters that enter an untrainable region in the target network to be trained receive network pruning by means of the processing result of the post-shifted BN layer, thus obtaining a universal pruned network that can ensure network sparsity, and the amount of data computation can be reduced when the pruned network is used.

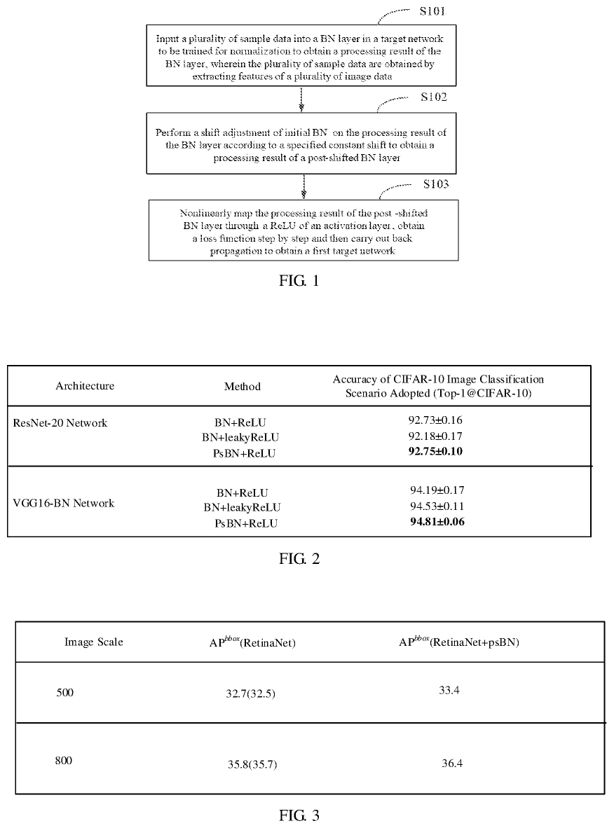

FIG. 1 shows a flow chart of a method for processing batch-normalized data according to the embodiment of the present disclosure. The method is applied to a device for processing batch-normalized data. For example, when the device is deployed on a terminal device or a server or other processing devices for execution, image classification, image detection, video processing and the like can be executed. The terminal device may be a user equipment (UE), a mobile device, a cell phone, a cordless telephone, a personal digital assistant (PDA), a hand-held device, a computing device, an on-board device, a wearable device or the like. In some possible implementations, the method can be implemented by a processor invoking computer-readable instructions stored in a memory. As shown in FIG. 1, the process includes:

Step S101: inputting a plurality of sample data into a BN layer in a target network to be trained for normalization to obtain a processing result of the BN layer, wherein the plurality of sample data are obtained by extracting features of a plurality of image data.

In one example, the target network to be trained can be a graph convolutional network for image processing (such as a convolutional neural network (CNN)), including: (1) an input layer: Configured for the input of sample data; (2) a convolutional layer: Uses a convolutional kernel to perform feature extraction and feature mapping; (3) an activation layer: Since convolution is also a linear operation, nonlinear mapping needs to be added, and the activation layer needs to be accessed. The activation layer includes a ReLU for nonlinear mapping to perform nonlinear mapping. Since the calculation of the convolutional layer is a linear computation, the activation layer can linearly map the output result of the convolutional layer once; (4) a pooling layer: Performs downsampling, and sparsifies a feature map to reduce the amount of data computation; (5) a fully-connected (FC) layer: Performs refitting at the tail of the CNN to reduce the loss of feature information; (6) an output layer: Configured to output a result. Some other functional layers can also be used in the middle, such as a BN layer for normalizing features in the convolutional neural network (CNN), a slice layer for separately learning certain (picture) data in different sections, a merge layer for merging independent branches of feature learning, etc.

In some possible implementations, the convolutional layer and the activation layer can be merged together as a convolutional layer, and the BN layer can be located in the input layer to preprocess features, or can be located in the convolutional layer. The specific architecture of the neural network adopted by the present disclosure is not limited to the description.

Step S102: performing a shift adjustment of initial BN on the processing result of the BN layer according to a specified constant shift (such as α) to obtain a processing result of a post-shifted BN layer.

In one example, a calculation formula for shift adjustment is shown as formula (1):

$$y = BN ( \hat{x} ) + α = γ \cdot \frac{\hat{x} - {μ}_{β}}{\sqrt{{σ}_{β}^{2} + ϵ}} + β + α \qquad ( 1 )$$

BA (\hat{x}) is a processing result of the BN layer (or referred to as a processing result of the original BN layer) obtained in Step (S101); \hat{x} is an input feature of the BN layer, and γ is a scaling coefficient of the BN layer; β is a shift coefficient of the BN layer; μ_{β} is a mean value of sample data; σ_{β} is a standard deviation of the sample data; and ε is a fixed constant, and may be equal to 10⁻⁵. The ReLU is kept unchanged, for example, ReLU(y)=max(0, y). y is a processing result of the post-shifted BN layer, and can be represented as post-shifted BN (psBN), which has the same expressing ability as BN, and when entering an untrainable region during training, feature parameters can be trained again. The performance of a network model can be increased according to post-shifted BN (psBN), for example, it can serve as classification of CIFAR-10 and object detection on MS-COCO2017.

Step S103: nonlinearly mapping the processing result of the post-shifted BN layer through an activation function ReLU of an activation layer, obtaining a loss function step by step and then carrying out back propagation to obtain a first target network.

In one example, the target network to be trained may be a BN+ReLU neural network, and the first target network obtained in Step S101 to Step S103 is a BN (psBN)+ReLU neural network.

In a complete example adopting the present disclosure, a plurality of sample data can be input into a batch normalization (BN) layer in the target network to be trained for normalization to obtain a processing result of the BN layer (ordinary BN or original BN). The processing result is specifically a processing result that is obtained after normalization and further linear transformation of normalization. The plurality of sample data are obtained by extracting features of a plurality of image data (a plurality of image data are acquired, a sample data set is obtained according to a plurality of feature parameters extracted from the plurality of image data, and the sample data set includes a plurality of sample data). In terms of normalization, a mean value and a variance are obtained from a batch of sample data (feature parameters) in BN, the sample data are normalized according to the mean value and the variance, and the normalized feature parameters are linearly transformed (BN multiplied by a scaling coefficient and a shift coefficient) to obtain a processing result of the BN layer (ordinary BN or original BN). A shift adjustment of initial BN is performed on the processing result of the BN layer according to a specified constant shift to obtain a processing result of the post-shifted BN layer. That is, an output of ordinary BN or original BN is added with a small constant shift (a symbol for the shift can be chosen according to the requirement of a user) to obtain the processing result of the post-shifted BN layer (a new BN layer output result). After the processing result of the post-shifted BN layer is linearly mapped by the activation function ReLU of the activation layer, back propagation for a loss function is carried out, and after iterative training, the first target network is obtained.

When the present disclosure is adopted, a shift adjustment is performed on initial BN by setting a constant shift to obtain a processing result of the post-shifted BN layer, so that network parameters that enter an untrainable region in the target network to be trained can be retransferred into a trainable region by means of the processing result of the post-shifted BN layer or the network parameters that enter the untrainable region in the target network to be trained can receive network pruning by means of the processing result of the post-shifted BN layer, thereby improving the performance of the network.

In a possible implementation, the inputting a plurality of sample data into a BN layer in a target network to be trained for normalization to obtain a processing result of the BN layer includes: based on a mean value (μ_{β}) and a variance (σ_{β}) corresponding to the plurality of sample data, normalizing the plurality of sample data to obtain a normalization result; and based on a scaling coefficient (γ) and a shift coefficient (β) of the BN layer, linearly transforming the normalization result to obtain the processing result of the BN layer.

When the present disclosure is adopted, a plurality of sample data can be normalized, and the normalization result is linearly transformed according to the scaling coefficient and the shift coefficient of the BN layer to obtain a processing result of the BN layer, thus reducing the degree of divergence of the sample data, which helps accelerate the training of the network.

In a possible implementation, the performing a shift adjustment of initial BN on the processing result of the BN layer according to a specified constant shift to obtain a processing result of a post-shifted BN layer includes: setting the constant shift to a positive number, and performing the shift adjustment of initial BN by means of the constant shift to obtain the processing result of the post-shifted BN layer.

When the present disclosure is adopted, the value of the constant shift is set as a positive number, and a shift adjustment is performed on initial BN according to the constant shift to obtain a processing result of the post-shifted BN layer, so that network parameters that enter an untrainable region in the target network to be trained can be retransferred into a trainable region by means of the processing result of the post-shifted BN layer.

In one example, α is a positive number, for example, the value of α is between 0.01 and 0.1, and can be compatible with the expressing ability of the BN layer, that is, while not changing the prior of the BN layer parameters and not causing adverse impact on the network, it has the effect of inhibiting the parameters from entering the untrainable region. Sample data are feature parameters in the initial BN layer. At the initial stage of network training or due to a high learning rate, the feature parameters enter the untrainable region, and according to the processing result of the post-shifted BN layer, the feature parameters can return into the trainable region again. Since the parameters are inhibited from entering the untrainable region, the expressing ability of the network is ensured, and the performance of the network is improved. Specifically speaking, when α is greater than 0, that is, the value is a positive number, because the parameters γ and β of the BN layer are attenuated to 0 at the same speed under the effect of weight attenuation/decay after entering the untrainable region, however, due to the existence of a positive constant α in the bias item, the bias item is ultimately greater than 0, causing the ReLU to enter a linear region (that is, the gradient can be returned via the ReLU), so that neutrons in the neural network are activated again (that is, the parameters of the BN layer enter the trainable region again), and therefore, when α is a positive number, the objective of sparsity inhibition can be achieved.

When the disclosure is adopted, the target network (such as a graph convolutional network for video data processing (such as image processing) among neural networks) is trained to improve its performance. Mainly for the BN+ReLU network, the ReLU is kept unchanged, and BN is adjusted to shift through a specified constant shift to obtain psBN, so that a trained target network is obtained as a psBN+ReLU network, and thereby network performance is optimized. The value of α is a positive number for inhibition (i.e. transferring the parameters into the trainable region), so that an undesirable sparsity result is removed when the network has sparsity.

In a possible implementation, the performing a shift adjustment of initial BN on the processing result of the BN layer according to a specified constant shift to obtain a processing result of a post-shifted BN layer includes: setting the constant shift to a negative number, and performing the shift adjustment of initial BN by means of the constant shift to obtain the processing result of the post-shifted BN layer.

When the present disclosure is adopted, the value of the constant shift is set as a negative number, a shift adjustment is performed on initial BN according to the constant shift to obtain a processing result of the post-shifted BN layer, and then network parameters that enter an untrainable region in the target network to be trained receive network pruning by means of the processing result of the post-shifted BN layer, thus obtaining a universal pruned network that can ensure network sparsity, and the amount of data computation can be reduced when the pruned network is used.

In one example, α is a negative number, for example, the value of a is between −0.1 and −0.01, and can be compatible with the expressing ability of the BN layer, that is, while not changing the prior of the BN layer parameters and not causing adverse impact on the network, it enables the network to have less parameters. Sample data are feature parameters in the initial BN layer, and at this point, more BN parameters will be in the untrainable region, thus causing part of channels to be pruned in the process of training. Since network pruning is promoted, network training or model-based reasoning is accelerated, and consequently, while the network has less parameters, the performance of the network is less influenced. Specifically speaking, the principle of α less than 0 is opposite to that of α greater than 0; the bias term added with the negative constant α can induce the input parameter entering the ReLU to be less than 0; the gradient cannot be returned via the ReLU; as a result, the parameters of the BN layer are attenuated to 0 under the effect of weight attenuation, realizing the function of network pruning, and therefore, when α is a negative number, the objective of promoting sparsity can be achieved.

When the disclosure is adopted, the target network (such as a graph convolutional network for video data processing (such as image processing) among neural networks) is trained to improve its performance. Mainly for the BN+ReLU network, the ReLU is kept unchanged, and BN is adjusted to shift through a specified constant shift to obtain psBN, so that a trained target network is obtained as a psBN+ReLU network, and thereby network performance is optimized. The value of α is a negative number for promotion, so that a pruned network is obtained.

In a possible implementation, the nonlinearly mapping the processing result of the post-shifted BN layer through a ReLU of an activation layer, obtaining a loss function step by step and then carrying out back propagation to obtain a first target network includes: after nonlinearly mapping the processing result of the post-shifted BN layer through the ReLU, entering a next layer for calculation to ultimately obtain the loss function; and based on back propagation for the loss function, obtaining the first target network. It should be pointed out that as the neural network is a multi-layer architecture, the post-shifted BN+ReLU described herein is merely the architecture of one of the layers of the neural network, and therefore, the output of this layer needs to be transferred layer by layer before the loss function is obtained ultimately.

When the present disclosure is adopted, by performing nonlinear mapping through the ReLU and then utilizing the loss function to perform back propagation, the amount of computation for obtaining a gradient by derivation will be reduced and part of output in the neural network will be zero due to the ReLU, which contribute to the formation of sparsity of the network.

For the first target network obtained by training, corresponding application scenarios include:

a method for image classification of the present disclosure, including: acquiring image data, and using the first target network obtained by the method in any one of the implementations of the present disclosure to classify the image data, so as to obtain an image classification result;

a method for image detection of the present disclosure, including: acquiring image data; and using the first target network obtained by the method in any one of the implementations of the present disclosure to detect a target region in the image data, so as to obtain an image detection result; and

a method for video processing of the present disclosure, including: acquiring a video image; and using the first target network obtained by the method in any one of the implementations of the present disclosure to perform at least one of the following video processing on the video image according to a preset processing strategy to obtain a video processing result: encoding, decoding or playback.

FIG. 2 shows a schematic diagram of a shift processing effect applied to the image classification scenario according to the embodiment of the present disclosure, wherein the BN+ReLU behavior employs a processing result obtained after image classification by a network to be trained, the BN+LeakyReLU behavior employs a processing result obtained after image classification by a generally optimized trained network, the psBN+ReLU behavior employs a processing result (such as average accuracy of multiple trainings) obtained after image classification by a first target network obtained by training the network in the present disclosure, and a ResNet-20 network and a VGG16-BN network are taken as examples of the network. It can be seen in FIG. 2 that the processing results obtained by the present disclosure are optimal among multiple results. When the present disclosure is adopted, for the BN+ReLU network, the ReLU is kept unchanged, and BN is adjusted to shift through a specified constant shift to obtain psBN, so that a first target network is obtained as a psBN+ReLU network, and thereby network performance is optimized. Like the ReLU, a leaky rectified linear unit (Leaky ReLU) is also an activation function, and is a variant of the ReLU. The output of the Leaky ReLU has a small slope relative to a negative value input. Since the derivative is always not zero, this can reduce the occurrence of silent neutrons in a neural network, allow gradient-based learning (although it will be slow), and solve the problem that neurons do not learn after the ReLU enters a negative interval.

FIG. 3 shows a schematic diagram of a shift processing effect applied to a transfer learning scenario according to an embodiment of the present disclosure. For image data with an image size of 500 or 800, in an image detection effect AP^{bbox}(RetinaNet) (i.e. average accuracy of detection) obtained by adopting a RetinaNet network, the values in the brackets are accuracies obtained by adopting a related technique, the values outside the brackets are results of image detection by the RetinaNet network reproduced by the inventor, and AP^{bbox}(RetinaNet+psBN) is detection accuracies obtained after image detection by a RetinaNet network with post-shifted BN obtained by utilizing the solution of the present disclosure to modify the RetinaNet network. It can be visually seen from FIG. 3 that the values obtained by adopting the present disclosure are higher, that is, the accuracies are higher than those obtained by the previous related technique, and apparently, the image detection effect achieved by adopting AP^{bbox}(RetinaNet+psBN) of the present disclosure is better.

A person skilled in the art should understand that in the method in the specific embodiment, the listed order of the steps may not necessarily be the execution order and does not limit the implementation process. The specific execution order of the steps should be determined according to functions and internal logic of the steps.

The method embodiments described above in the present disclosure can be combined with each other to form a combined embodiment as long as principles and logic are not violated. For brevity, details are not described herein.

In addition, the present disclosure further provides a device for processing batch-normalized data, an electronic device, a computer-readable storage medium, and a program, which can all be used to implement any method for processing batch-normalized data provided by the present disclosure. Related technical solutions and information are described in the method embodiment. Details are not described herein.

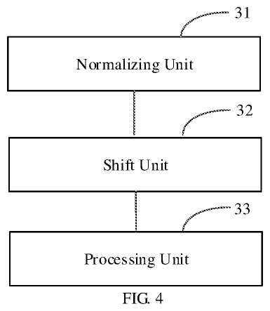

FIG. 4 shows a block diagram of the device for processing batch-normalized data according to the embodiment of the present disclosure. As shown in FIG. 4, the device includes: a normalizing unit 31, configured to input a plurality of sample data into a BN layer in a target network to be trained for normalization to obtain a processing result of the BN layer, wherein the plurality of sample data are obtained by extracting features of a plurality of image data; a shift unit 32, configured to perform a shift adjustment of initial BN on the processing result of the BN layer according to a specified constant shift to obtain a processing result of a post-shifted BN layer; and a processing unit 33, configured to nonlinearly map the processing result of the post-shifted BN layer through a ReLU of an activation layer, obtain a loss function step by step and then carry out back propagation to obtain a first target network.

In a possible implementation, the normalizing unit is configured for: normalizing the plurality of sample data according to a mean value and a variance corresponding to the plurality of sample data to obtain a normalization result; and linearly transforming the normalization result according to a scaling coefficient and a shift coefficient of the BN layer to obtain a processing result of the BN layer.

In a possible implementation, the shift unit is configured for: setting the constant shift as a positive number, and performing the shift adjustment of initial BN through the constant shift to obtain the processing result of the post-shifted BN layer. Thus, network parameters that enter an untrainable region in the target network to be trained can be retransferred into a trainable region by means of the processing result of the post-shifted BN layer.

In a possible implementation, the shift unit is configured for: setting the constant shift as a negative number, and performing the shift adjustment of initial BN through the constant shift to obtain the processing result of the post-shifted BN layer. Thus, the network parameters that enter the untrainable region in the target network to be trained receive network pruning by means of the processing result of the post-shifted BN layer to obtain a pruned network.

In a possible implementation, the processing unit is configured for: after nonlinearly mapping the processing result of the post-shifted BN layer through the ReLU, entering a next layer for calculation to ultimately obtain the loss function; and based on back propagation for the loss function, obtaining the first target network.

In a possible implementation, a value range of the constant shift is between 0.01 and 0.1.

In a possible implementation, a value range of the constant shift is between −0.1 and −0.01.

A device for image classification of the present disclosure includes: a first acquiring unit, configured to acquire image data; and a first processor, configured to use the first target network obtained by the method of the present disclosure to classify the image data, so as to obtain an image classification result.

A device for image detection of the present disclosure includes: a second acquiring unit, configured to acquire a video image; and a second processor, configured to use the first target network obtained by the method of the present disclosure to detect a target region in the image data, so as to obtain an image detection result.

A device for video processing of the present disclosure includes: a third acquiring unit, configured to acquire a video image; and a third processor, configured to use the first target network obtained by the method of the present disclosure to perform at least one of the following video processing on the video image according to a preset processing strategy to obtain a video processing result: encoding, decoding or playback.

It should be pointed out that the acquisition operations performed by the first acquiring unit, second acquiring unit and third acquiring unit are not limited to an acquisition method. For example, the first acquiring unit, the second acquiring unit and the third acquiring unit themselves may perform the acquisition operations (such as acquisition operation on image data, a video image or the like) to obtain operation results. For another example, the first acquiring unit, the second acquiring unit and the third acquiring unit may communicate with another processing device capable of performing acquisition operation in a wireless or wired communication manner and obtain an operation result from the acquisition operation (such as acquisition operation on image data, video image or the like) performed by the processing device. Interfaces for the wired communication manner are not limited to serial communication interfaces, bus interfaces and other types of interfaces.

In some embodiments, functions or modules included in the device provided by the embodiments of the present disclosure can be used to perform the method described by the method embodiment, and its specific implementation can refer to the description of the method embodiment, and will not be repeated for brevity.

An embodiment of the present disclosure further provides a computer-readable storage medium. The computer-readable storage medium has stored thereon a computer program instruction that, when executed by a processor, causes the processor to perform the abovementioned method. The computer-readable storage medium can be a volatile computer-readable storage medium or a non-volatile computer-readable storage medium.

An embodiment of the present disclosure further provides an electronic device, including: a processor, and a memory configured to store an instruction executable by the processor, wherein the processor is configured to perform the abovementioned method.

The electronic device can be provided as a terminal, a server, or a device of another form.

An embodiment of the present disclosure further provides a computer program. The computer program includes a computer-readable code that, when being run in an electronic device, causes a processor in the electronic device to perform the abovementioned method.

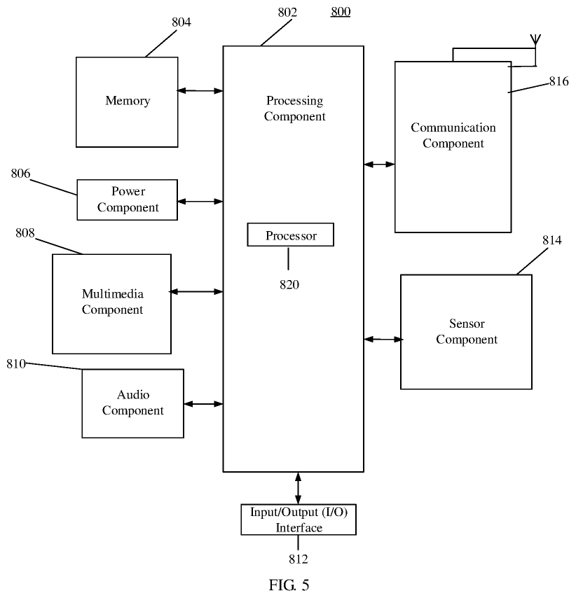

FIG. 5 is a block diagram of an electronic device 800 according to an exemplary embodiment. For example, the electronic device 800 can be a terminal such as a mobile phone, a computer, a digital broadcasting terminal, a message transceiver device, a game console, a tablet device, a medical device, a fitness device, and a personal digital assistant.

Referring to FIG. 5, the electronic device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute an instruction, to complete all of or some of the steps of the method. In addition, the processing component 802 may include one or more modules, to facilitate interaction between the processing component 802 and another component. For example, the processing component 802 may include a multimedia module, so as to facilitate interaction between the multimedia component 808 and the processing component 802.

The memory 804 is configured to store various types of data to support an operation on the electronic device 800. Examples of the data include instructions for any application or method operated on the electronic device 800, contact data, phone book data, messages, pictures or videos. The memory 804 can be implemented using any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 supplies power to the various components of the electronic device 800. The power component 806 may include a power management system, one or more power supplies, and other components associated with power generation, management, and distribution in the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensor can not only sense a boundary of a touch action or a swipe action, but also detect duration and pressure associated with the touch action or the swipe action. In some embodiments, the multimedia component 808 includes a front-facing camera and/or a rear-facing camera. The front-facing camera and/or the rear-facing camera can receive external multimedia data when the electronic device 800 is in an operation mode, such as a photo mode or a video mode. Each of the front-facing camera and the rear-facing camera can be a fixed optical lens system or have focal length and optical zoom capability.

The audio component 810 is configured to output and/or input an audio signal. For example, the audio component 810 includes a microphone (MIC) configured to receive an external audio signal when the electronic device 800 is in an operation mode, such as a call mode, a recording mode, and a voice recognition mode. The received audio signal can be further stored in the memory 804 or transmitted via the communication component 816. In some embodiments, the audio component 810 further includes a speaker to output an audio signal.

The I/O interface 812 provides an interface between the processing component 802 and a peripheral interface module, and the peripheral interface module can be a keyboard, a click wheel, buttons, and the like. The buttons may include, but are not limited to, a home button, a volume button, a start button, and a lock button.

The sensor component 814 includes one or more sensors to provide status assessments of various aspects of the electronic device 800. For example, the sensor component 814 can detect an on/off status of the electronic device 800 and a relative positioning of a component, such as a monitor or a keypad of the electronic device 800. The sensor component 814 can further detect a change in position of the electronic device 800 or a component of the electronic device 800, whether the user is in contact with the electronic device 800 or not, an orientation or an acceleration/deceleration of the electronic device 800, and a change in temperature of the electronic device 800. The sensor component 814 can include a proximity sensor, configured to detect the presence of a nearby object without any physical contact. The sensor component 814 can further include a light sensor, such as a CMOS or CCD image sensor, for use in imaging applications. In some embodiments, the sensor component 814 can further include an acceleration sensor, a gyroscope sensor, a magnetic sensor, a pressure sensor, or a temperature sensor.

The communication component 816 is configured to facilitate wired or wireless communication between the electronic device 800 and another device. The electronic device 800 can access a wireless network based on a communication standard, such as WiFi, 2G, or 3G, or a combination thereof. In one exemplary embodiment, the communication component 816 receives a broadcast signal or broadcast-related information from an external broadcast management system via a broadcast channel. In one exemplary embodiment, the communication component 816 further includes a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In one exemplary embodiment, the electronic device 800 may be implemented with one or more application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the method.

In one exemplary embodiment, a computer-readable storage medium is further provided, such as the memory 804 storing a computer program instruction, and the computer program instruction can be executed by the processor 820 of the electronic device 800 to complete the method.

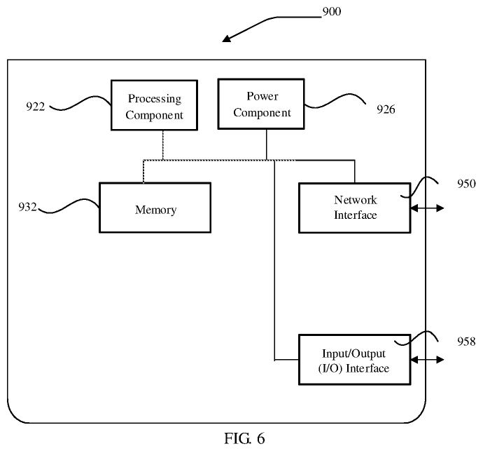

FIG. 6 is a block diagram of an electronic device 900 according to an exemplary embodiment. For example, the electronic device 900 can be provided as a server. Referring to FIG. 6, the electronic device 900 includes a processing component 922, which further includes one or more processors, and storage resources represented by a memory 932 for storing an instruction executable by the processing component 922, for example, an application. The application stored in the memory 932 may include one or more modules each corresponding to a set of instructions. Further, the processing component 922 is configured to execute instructions to perform the method.

The electronic device 900 may further include a power component 926 configured to perform power management for the electronic device 900, a wired or wireless network interface 950 configured to connect the electronic device 900 to a network, and an input/output (I/O) interface 958. The electronic device 900 can operate based on an operating system stored in the memory 932, such as Windows Server™, MAC OS X™, Unix™ Linux™, or FreeBSD™.

In one exemplary embodiment, a computer-readable storage medium is further provided, such as the memory 932 storing a computer program instruction, and the computer program instruction can be executed by the processing component 922 of the electronic device 900 to complete the method.

The present disclosure may be provided as a system, a method, and/or a computer program product. The computer program product may include a computer-readable storage medium having computer-readable program instructions thereon to enable the processor to implement various aspects of the present disclosure.

The computer-readable storage medium can be a tangible device that can retain and store instructions for use by an instruction execution device. The computer-readable storage medium can be, for example, but is not limited to, an electrical storage device, a magnetic storage device, an optical storage device, an electromagnetic storage device, a semiconductor storage device, or any suitable combination thereof. A non-exhaustive list of more specific examples of the computer-readable storage medium includes: a portable computer disk, a hard disk, a random access memory (RAM), a read-only memory (ROM), an erasable programmable read-only memory (EPROM or a flash memory), a static random access memory (SRAM), a portable compact disc read-only memory (CD-ROM), a digital versatile disc (DVD), a memory stick, a floppy disk, a mechanical coding device such as a punched card or a raised structure in a groove having instructions stored thereon, and any suitable combination thereof. The computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-readable program instruction described herein can be downloaded to respective computing/processing devices from the computer-readable storage medium or to an external computer or external storage device via a network such as the Internet, a local area network, a wide area network, and/or a wireless network. The network may include a copper transmission cable, optical fiber transmission, wireless transmission, a router, a firewall, a switch, a gateway computer, and/or an edge server. A network adapter card or network interface in each computing/processing device receives the computer-readable program instruction from the network and forwards the computer-readable program instruction for storage in the computer-readable storage medium within the respective computing/processing device.

The computer program instruction used to perform the operation of the present disclosure may be an assembly instruction, an instruction set architecture (ISA) instruction, a machine instruction, a machine-related instruction, microcode, a firmware instruction, status setting data, or source code or object code written in any combination of one or more programming languages. The programming languages include object-oriented programming languages such as Smalltalk and C++, and conventional procedural programming languages such as “C” language or similar programming language. The computer-readable program instruction can execute entirely on a user computer, partly on a user computer, as a stand-alone software package, partly on a user computer and partly on a remote computer, or entirely on a remote computer or server. In the latter scenario, the remote computer can be connected to the user computer via any type of network, including a local area network (LAN) or a wide area network (WAN), or the connection can be made to an external computer (for example, via the Internet using an Internet Service Provider). In some embodiments, an electronic circuit, such as a programmable logic circuit, a field programmable gate array (FPGA) or a programmable logic array (PLA), may be customized by using status information of the computer-readable program instruction. The electronic circuit can execute the computer-readable program instruction to implement various aspects of the present disclosure.

Various aspects of the present disclosure are described herein with reference to the flowcharts and/or block diagrams of the method, the device (system), and the computer program product according to the embodiments of the present disclosure. It is to be understood that each block in the flowcharts and/or the block diagrams and a combination of blocks in the flowcharts and/or the block diagrams can be implemented by the computer-readable program instruction.

These computer-readable program instructions may be provided for a general-purpose computer, a dedicated computer, or a processor of other programmable data processing devices to generate a machine, so that when the instructions are executed by the computer or the processor of any other programmable data processing devices, an device for implementing the specific functions/actions in one or more blocks in the flowcharts and/or the block diagrams is generated. These computer-readable program instructions can alternatively be stored in the computer-readable storage medium. These instructions direct the computer, the programmable data processing device, and/or other devices to work in a specific manner Therefore, the computer-readable medium that stores the instructions includes an artifact, and the artifact includes instructions to implement various aspects of the functions/actions specified in one or more blocks in the flowcharts and/or block diagrams.

These computer-readable program instructions may alternatively be loaded onto a computer, another programmable data processing device, or other devices, so that a series of operation steps are performed on the computer, the another programmable data processing device, or the other devices, thereby generating a computer-implemented process. Therefore, the instructions executed on the computer, the another programmable data processing device, or the other devices can implement the specific functions/actions in one or more blocks in the flowcharts and/or block diagrams.

The flowcharts and block diagrams in the accompanying drawings show architectures, functions, and operations of possible implementations of the system, the method, and the computer program product according to multiple embodiments of the present disclosure. In this regard, each block in the flowcharts or block diagrams may represent a module, a program segment, or a part of an instruction, and the module, the program segment, or the part of the instruction includes one or more executable instructions for implementing specified logical functions. In some alternative implementations, the functions marked in the blocks can also be performed in an order different from that marked in the accompanying drawings. For example, two consecutive blocks can actually be executed in parallel, and they can sometimes be executed in reverse order, depending on the functions involved. It should also be noted that each block in the block diagrams and/or flowcharts and a combination of blocks in the block diagrams and/or flowcharts can be implemented by a dedicated hardware-based system that performs specified functions or actions, or can be implemented by a combination of dedicated hardware and computer instructions.

Without departing from the logic, the various embodiments of the present application can be combined, and the emphases of the descriptions of the various embodiments are different. For the emphases of the descriptions, see the records of the other embodiments.

The embodiments of the present disclosure have been described above, but the description is illustrative and not exhaustive. The present disclosure is not limited to the disclosed embodiments. Many modifications and variations will be apparent to those of ordinary skill in the art without departing from the scope and spirit of the embodiments. The choice of terms used herein is intended to best explain the principles, practical applications, or technical improvements of the technology in the market in the embodiments, or to enable those of ordinary skill in the art to understand the embodiments disclosed herein.

1. A method for processing batch-normalized data, comprising:
inputting a plurality of sample data into a batch normalization (BN) layer in a target network to be trained for normalization to obtain a processing result of the BN layer, wherein the plurality of sample data are obtained by extracting features of a plurality of image data;
performing a shift adjustment of initial BN on the processing result of the BN layer according to a specified constant shift to obtain a processing result of a post-shifted BN layer; and
nonlinearly mapping the processing result of the post-shifted BN layer through a rectified linear unit (ReLU) of an activation layer, obtaining a loss function step by step and then carrying out back propagation to obtain a first target network.

2. The method according to claim 1, wherein the inputting a plurality of sample data into a BN layer in a target network to be trained for normalization to obtain a processing result of the BN layer comprises:
based on a mean value and a variance corresponding to the plurality of sample data, normalizing the plurality of sample data to obtain a normalization result; and
based on a scaling coefficient and a shift coefficient of the BN layer, linearly transforming the normalization result to obtain the processing result of the BN layer.

3. The method according to claim 1, wherein the performing a shift adjustment of initial BN on the processing result of the BN layer according to a specified constant shift to obtain a processing result of a post-shifted BN layer comprises:
setting the constant shift as a positive number, and performing the shift adjustment of initial BN through the constant shift to obtain the processing result of the post-shifted BN layer.

4. The method according to claim 1, wherein the performing a shift adjustment of initial BN on the processing result of the BN layer according to a specified constant shift to obtain a processing result of a post-shifted BN layer comprises:
setting the constant shift as a negative number, and performing the shift adjustment of initial BN through the constant shift to obtain the processing result of the post-shifted BN layer.

5. The method according to claim 1, wherein the nonlinearly mapping the processing result of the post-shifted BN layer through a ReLU of an activation layer, obtaining a loss function step by step and then carrying out back propagation to obtain a first target network comprises:
after nonlinearly mapping the processing result of the post-shifted BN layer through the ReLU, entering a next layer for calculation to ultimately obtain the loss function; and
based on back propagation for the loss function, obtaining the first target network.

6. The method according to claim 3, wherein a value range of the constant shift is between 0.01 and 0.1.

7. The method according to claim 4, wherein a value range of the constant shift is between −0.1 and −0.01.

8. An electronic device, comprising:
a processor; and
a memory configured to store an instruction that, when executed by the processor, causes the processor to perform the following operations including:
inputting a plurality of sample data into a batch normalization (BN) layer in a target network to be trained for normalization to obtain a processing result of the BN layer, wherein the plurality of sample data are obtained by extracting features of a plurality of image data;
performing a shift adjustment of initial BN on the processing result of the BN layer according to a specified constant shift to obtain a processing result of a post-shifted BN layer; and
nonlinearly mapping the processing result of the post-shifted BN layer through a rectified linear unit (ReLU) of an activation layer, obtaining a loss function step by step and then carrying out back propagation to obtain a first target network.

9. The electronic device according to claim 8, wherein the processor is configured for:
based on a mean value and a variance corresponding to the plurality of sample data, normalizing the plurality of sample data to obtain a normalization result; and
based on a scaling coefficient and a shift coefficient of the BN layer, linearly transforming the normalization result to obtain the processing result of the BN layer.

10. The electronic device according to claim 8, wherein the processor is configured for:
setting the constant shift as a positive number, and performing the shift adjustment of initial BN through the constant shift to obtain the processing result of the post-shifted BN layer.

11. The electronic device according to claim 8, wherein the processor is configured for:
setting the constant shift as a negative number, and performing the shift adjustment of initial BN through the constant shift to obtain the processing result of the post-shifted BN layer.

12. The electronic device according to claim 8, wherein the processor is configured for:
after nonlinearly mapping the processing result of the post-shifted BN layer through the ReLU, entering a next layer for calculation to ultimately obtain the loss function; and
based on back propagation for the loss function, obtaining the first target network.

13. The electronic device according to claim 10, wherein a value range of the constant shift is between 0.01 and 0.1.

14. The electronic device according to claim 11, wherein a value range of the constant shift is between −0.1 and −0.01.

15. A non-transitory computer-readable storage medium, having stored thereon a computer program instruction that, when executed by a processor, causes the processor to perform a method for processing batch-normalized data, the method comprising:
inputting a plurality of sample data into a batch normalization (BN) layer in a target network to be trained for normalization to obtain a processing result of the BN layer, wherein the plurality of sample data are obtained by extracting features of a plurality of image data;
performing a shift adjustment of initial BN on the processing result of the BN layer according to a specified constant shift to obtain a processing result of a post-shifted BN layer; and
nonlinearly mapping the processing result of the post-shifted BN layer through a rectified linear unit (ReLU) of an activation layer, obtaining a loss function step by step and then carrying out back propagation to obtain a first target network.

16. The non-transitory computer-readable storage medium according to claim 15, wherein the inputting a plurality of sample data into a BN layer in a target network to be trained for normalization to obtain a processing result of the BN layer comprises:
based on a mean value and a variance corresponding to the plurality of sample data, normalizing the plurality of sample data to obtain a normalization result; and
based on a scaling coefficient and a shift coefficient of the BN layer, linearly transforming the normalization result to obtain the processing result of the BN layer.

17. The non-transitory computer-readable storage medium according to claim 15, wherein the performing a shift adjustment of initial BN on the processing result of the BN layer according to a specified constant shift to obtain a processing result of a post-shifted BN layer comprises:
setting the constant shift as a positive number, and performing the shift adjustment of initial BN through the constant shift to obtain the processing result of the post-shifted BN layer; or
setting the constant shift as a negative number, and performing the shift adjustment of initial BN through the constant shift to obtain the processing result of the post-shifted BN layer.

18. The non-transitory computer-readable storage medium according to claim 15, wherein the nonlinearly mapping the processing result of the post-shifted BN layer through a ReLU of an activation layer, obtaining a loss function step by step and then carrying out back propagation to obtain a first target network comprises:
after nonlinearly mapping the processing result of the post-shifted BN layer through the ReLU, entering a next layer for calculation to ultimately obtain the loss function; and
based on back propagation for the loss function, obtaining the first target network.

19. The non-transitory computer-readable storage medium according to claim 17, wherein in the case of setting the constant shift as the positive number, a value range of the constant shift is between 0.01 and 0.1.

20. The non-transitory computer-readable storage medium according to claim 17, wherein in the case of setting the constant shift as the negative number, a value range of the constant shift is between −0.1 and −0.01.
